(19) United States
(12) Patent Application Publication
(10) Pub. No.: US 2018/0130037 A1
(43) Pub. Date: May 10, 2018

(54) ON DEMAND CASH NETWORK

(71) Applicant: CA, Inc., New York, NY (US)

(72) Inventors: Narendra DHULIPALLA, Hyderabad (IN); Madhusudhan GANDA, Thyagaraja Nagar (IN); Sumit GUPTA, Bangalore (IN); Ramanuja CHARYULU, East Setauket, NY (US); Kiran KUMAR B.S., Thyagaraja Nagar (IN); Swapnel SHRIVASTAVA, Bommanahalli (IN)

(73) Assignee: CA, Inc.

(21) Appl. No.: 15/347,360

(22) Filed: Nov. 9, 2016

(51) Int. Cl. G06Q 20/10; H04W 4/02; G06Q 40/02; H04W 4/14

(52) U.S. Cl. CPC G06Q 20/102; H04W 4/14; G06Q 40/02; H04W 4/02

(57) ABSTRACT

A method includes determining, in response to receiving a request to initiate a transaction from a user, a set of transaction servicers that are located within a predetermined distance of a current location of the user, wherein each transaction servicer is an account holder. The method further includes determining, for each of the transaction servicers in the set, whether the transaction servicer has enough currency to complete the transaction. The method further includes transmitting identifying information for each transaction servicer that has enough currency to complete the transaction to the user. The method further includes, in response to receiving a confirmation that the transaction has been completed, debiting a cash amount of the transaction from an account of the user at an issuing bank.

### BACKGROUND

The present disclosure relates to the exchange of funds, and, more specifically, to systems and methods for an on-demand cash network in which account-holders fulfill transaction requests from other account-holders.

Banks, credit unions, and other financial institutions require access to cash to meet the fluctuating demand requirements of their customers. Certain cash-points associated with a financial institution may, over time, receive a large number of withdrawal requests, contributing to a shortfall in currency reserves at that location. Other cash-points may receive a disproportionate number of cash deposits, and accumulate substantial cash reserves. This imbalance of reserve currency, vault cash, or cash-on-hand presents a variety of risks and inefficiencies for banks as well as bank customers seeking withdraws from cash-points such as Automated Teller Machines (ATMs).

Allocation of cash reserves throughout a financial institution's cash-points is critical to accommodating large cash withdrawals and other customer requests. Unexpected increases in currency demand in disparate geographic regions may cause currency shortages in certain bank locations. Unpredictable currency shortages are not only inefficient for financial institutions but also frustrating for consumers who expect all cash-points to be capable of fulfilling any transaction request. Further, not all currency is equally desirable for every purpose. Fulfillment of certain currency demand requests requires delivery of a particular caliber or quality of banknote. For example, ATM's require higher quality currency.

Technology in the field of currency processing systems has yielded advancements in currency counting, counterfeit detection, and fitness calculation, enabling most businesses to obtain devices that automatically count, sort, and account for cash inventories. In addition, financial institutions have improved customer technology thereby increasing customer communications. Particular devices may be capable of connecting to a network and providing output to a software system.

Systems and methods described herein may enable a user to initiate a transaction with a transaction servicer at a particular ATM. The present disclosure describes systems and methods for determining a set of transaction servicers that are located within a predetermined distance of a current location of a user. The systems and methods may further determine, for each of the transaction servicers in the set, whether the transaction servicer has enough currency to complete a transaction initiated by the user. Further, the systems and methods herein may debit a cash amount of the transaction from an account of the user in response to receiving a confirmation that the transaction has been completed.

### BRIEF SUMMARY

According to an aspect of the present disclosure, a method may include several processes. In particular, the method may include receiving a request to initiate a transaction from a user. The method may also include determining a set of transaction servicers that are located within a predetermined distance of a current location of the user. In addition, the method may also include determining whether a transaction servicer has enough currency to complete the transaction. Further, the method may include transmitting identifying information for each transaction servicer that has enough currency to complete the transaction to the user. The method may also include debiting a cash amount of the transaction from an account of the user at an issuing bank.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements of a non-limiting embodiment of the present disclosure.

FIG. 1 is a schematic representation of a transaction system ecosystem of a non-limiting embodiment of the present disclosure.

FIG. 2 is a schematic representation of a transaction system configured to interact with the transaction system ecosystem.

FIG. 3 illustrates communication points in a transaction system ecosystem according to a non-limiting embodiment of the present disclosure.

FIG. 4 is a flow chart for a method for executing a transaction according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Each activity in the present disclosure may be executed on one, some, or all of one or more processors. In some non-limiting embodiments of the present disclosure, different activities may be executed on different processors.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to monetary transactions, systems and methods disclosed herein may be related to any field involving exchanging resources. Moreover, certain examples disclosed herein may be described with respect to consumer or business solutions, or any other field that may involve exchange of goods. Certain embodiments described in the present disclosure are merely provided as example implementations of the processes described herein.

Financial institutions strive to provide their customers access to funds in multiple locations. ATMs are deployed for quick access to cash at the customer's convenience. However, the presence of an ATM does not guarantee that funds will be available at all times. In some countries, ATMs often run out of funds at popular locations or during heavy withdraw times. As a result, customers often experience tension and anxiety.

Systems and methods disclosed herein aim to increase customer satisfaction and more efficiently complete transactions by providing a system for account-holders of a financial institution to exchange currency. Systems and methods disclosed herein may involve a financial institution receiving a transaction request form a user associated with an account at the financial institution. Systems and methods disclosed herein may determine whether transaction servicers have enough currency to complete the transaction. In addition, systems and methods disclosed herein may transmit to the user identifying information for each transaction servicer that has enough currency to complete the transaction. Further, in response to receiving a confirmation that the transaction has been completed, systems and methods herein may debit a cash amount of the transaction from an account of the user at an issuing bank.

The teachings of the present disclosure may reference specific example “device.” For example, an “device” can include may refer to a smartphone, tablet, desktop computer, laptop, Global Positioning System (GPS) device, satellite communication terminal, radio communication terminal, or any other device capable of receiving input. For example, a mobile device may be equipped with an application capable of communicating with a financial institution. Any device with such capabilities is contemplated within the scope of the present disclosure.

In a first example, systems and methods disclosed herein may determine, in response to receiving a request to initiate a transaction from a user, a set of transaction servicers that are located within a predetermined distance of a current location of the user, wherein each transaction servicer is an account holder. Systems and methods disclosed herein may further determine, for each of the transaction servicers in the set, whether the transaction servicer has enough currency to complete the transaction. Systems and methods disclosed herein may further transmit identifying information for each transaction servicer that has enough currency to complete the transaction to the user. Systems and methods disclosed herein may also, in response to receiving a confirmation that the transaction has been completed, apply the transaction to a corresponding account of the user.

In a second example, non-limiting embodiments of the present disclosure may include a processing system configured to perform processes including, in response to receiving a request to initiate a transaction from a user, determining a set of transaction servicers that are located within a predetermined distance of a current location of the user, wherein each transaction servicer is an account holder. In addition, the processing system may be configured to perform processes including determining, for each of the transaction servicers in the set, whether the transaction servicer has enough currency to complete the transaction. Further, the processing system may be configured to perform processes including transmitting identifying information for each transaction servicer that has enough currency to complete the transaction to the user. The processing system may be configured to perform processes including determining that the transaction has been fulfilled by a first transaction servicer of the set of transaction servicers based on a confirmation received from a mobile device of the user. In addition, the processing system may be configured to perform processes including, in response to determining that the transaction has been fulfilled by a first transaction servicer of the set of transaction servicers, debiting a cash amount of the transaction from an account of the user at an issuing bank, and crediting the cash amount of the transaction to the account of the first transaction servicer at the issuing bank.

In a third example, systems and methods disclosed herein may determine in response to receiving a request to initiate a transaction from a user, a set of transaction servicers that are located within a predetermined distance of a current location of the user, wherein each transaction servicer is an account holder. Systems and methods disclosed herein may further determine, for each of the transaction servicers in the set, whether the transaction servicer has enough currency to complete the transaction. Systems and methods disclosed herein may also transmit identifying information for each transaction servicer that has enough currency to complete the transaction to the user. Further, systems and methods disclosed herein may determine that the transaction has been fulfilled by a first transaction servicer of the set of transaction servicers based on a confirmation received from a mobile device of the user. Systems and methods disclosed herein may, in response to determining that the transaction has been fulfilled in person by a first transaction servicer of the set of transaction servicers, debit a cash amount of the transaction from an account of the user at an issuing bank, and credit the cash amount of the transaction and an interest based on the cash amount to the account of the first transaction servicer at the issuing bank.

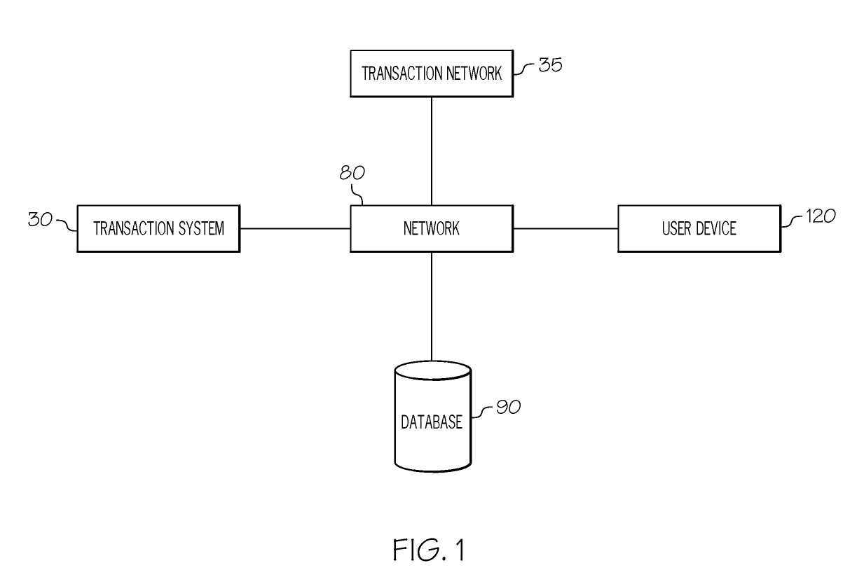

FIG. 1 is a schematic representation of a transaction system ecosystem of a non-limiting embodiment of the present disclosure. A transaction system 30 may communicate with a database 90 and user device 120 via a network 80. Further, transaction system 30 may communicate with a transaction network 35 via the network 80. In some non-limiting embodiments of the present disclosure, transaction network 35 may include a single transaction servicer. In other non-limiting embodiments of the present disclosure, transaction network 35 may include multiple transaction servicers. In some non-limiting embodiments of the present disclosure, transaction system 30 may directly communicate with user device 120 if transaction system 30 is installed on the user device 120. User device 120 may be a mobile device with an application capable of communicating with transaction system 30.

Network 80 may comprise one or more entities, which may be public, private, or community based. Network 80 may permit the exchange of information and services among users/entities that are connected to such network 80. In certain configurations, network 80 may be a local area network, such as an intranet. Further, network 80 may be a closed and/or private network/cloud in certain configurations, and an open network/cloud in other configurations. Network 80 may facilitate wired or wireless communications of information and provisioning of services among users that are connected to network 80.

Network 80 may comprise one or more clouds, which may be public clouds, private clouds, or community clouds. Each cloud may permit the exchange of information and the provisioning of services among devices and/or applications that are connected to such clouds. Network 80 may include a wide area network, such as the Internet; a local area network, such as an intranet; a cellular network, such as a network using CDMA, GSM, 3G, 4G, LTE, or other protocols; a machine-to-machine network, such as a network using the MQTT protocol; another type of network; or some combination of the aforementioned networks. Network 80 may be a closed, private network, an open network, or some combination thereof and may facilitate wired or wireless communications of information among devices and/or applications connected thereto.

Network 80 may include a plurality of devices, which may be physical devices, virtual devices (e.g., applications running on physical devices that function similarly to one or more physical device), or some combination thereof. The devices within network 80 may include, for example, one or more of general purpose computing devices, specialized computing devices, mobile devices, wired devices, wireless devices, passive devices, routers, switches, mainframe devices, monitoring devices, infrastructure devices, other devices configured to provide information to and/or receive information from service providers and users, and software implementations of such.

In some non-limiting embodiments of the present disclosure, user device 120 may be any type of computer such as, for example, a desktop computer. In other non-limiting embodiments, user device 120 may be a mobile device such as a mobile phone, laptop, tablet, any portable device, etc. Mobile electronic devices may be part of a communication network such as a local area network, wide area network, cellular network, the Internet, or any other suitable network. Mobile devices may be powered by a mobile operating system, such as Apple Inc.'s iOS® mobile operating system or Google Inc.'s Android® mobile operating system, for example. A mobile electronic device may use a communication network to communicate with other electronic devices, for example, to access remotely-stored data, access remote processing power, access remote displays, provide locally-stored data, provide local processing power, or provide access to local displays. For example, networks may provide communication paths and links to servers, which may host applications, content, and services that may be accessed or utilized by users via mobile electronic devices. The content may include text, video data, audio data, user settings or other types of data. Networks may use any suitable communication protocol or technology to facilitate communication between mobile electronic devices, such as, for example, BLUETOOTH, IEEE WI-FI (802.11a/b/g/n/ac), or Transmission Control Protocol/Internet Protocol (TCP/IP).

In addition, transaction system 30 may use network 80 to communicate with a user device 120. In some non-limiting embodiments of the present disclosure, user device 120 may communicate with transaction system 30 via network 80. In some non-limiting embodiments of the present disclosure, transaction system 30 may be located on user device 120 associated with a user, and transaction system 30 may support communications between the user device 120 and a financial institution. In some non-limiting embodiments of the present disclosure, transaction system 30 may authenticate a user identity of a user on the user device 120 in order to streamline communications regarding transaction requests to other entities, such as, for example, transaction servicers or a financial institution.

In some non-limiting embodiments, user device 120 may communicate with transaction system 30 using a cellular network, such as 3G or LTE, for example, or other communication protocols or methods, such as Wi-Fi or NFC, for example. Further, user device 120 may include one or more applications that provide a user interface, which may display alerts, alarms, and/or notifications associated with transaction system 30 disclosed herein, and which may provide one or more options for interaction with transaction system 30.

The transaction system 30 environment may also include a database 90. Database 90 may include, for example, additional servers, data storage, and resources. Transaction system 30 may receive additional data, account information, previously fulfilled transaction requests, transaction servicing histories, transaction servicer current currency and denomination status, or any data used by transaction system 30 from database 90. Database 90 may be any conventional database or data infrastructure. For example, database 90 may include scaled out data architectures (i.e., Apache Hadoop) and/or persistent, immutable stores/logging systems.

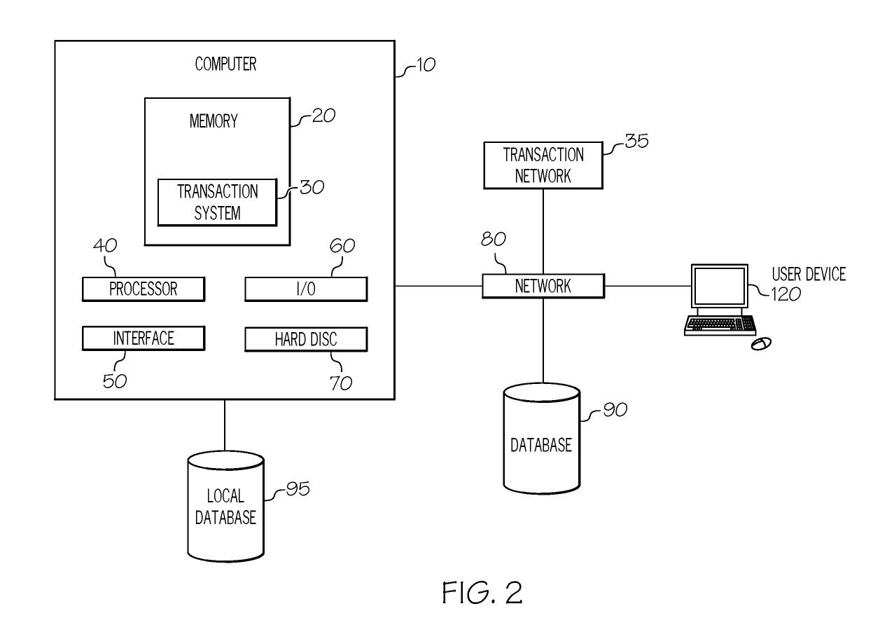

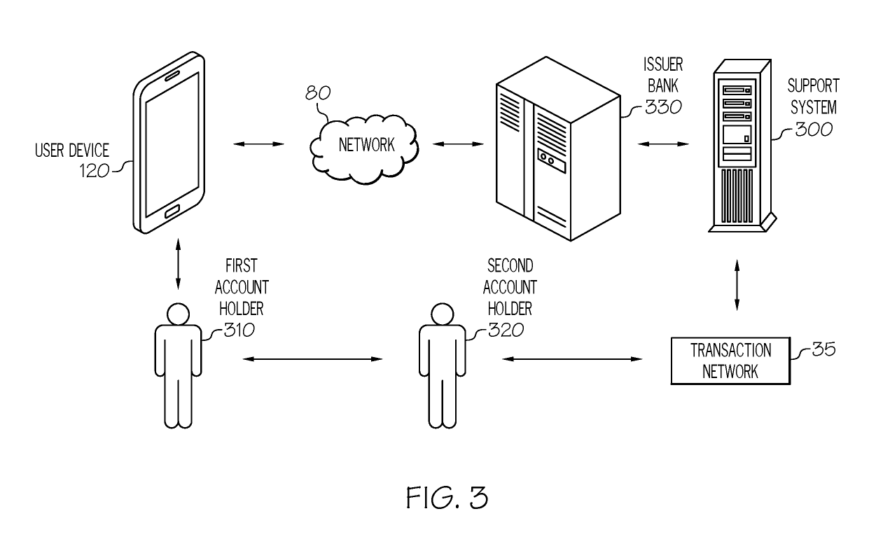

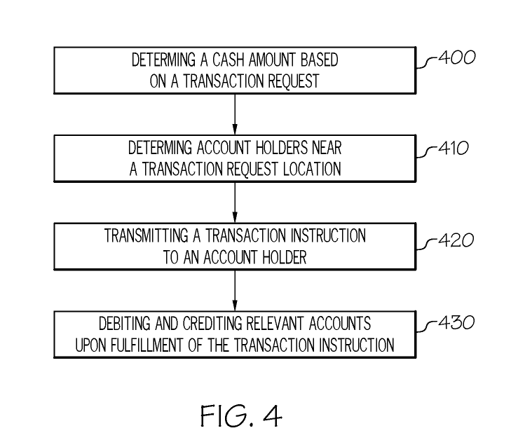

Referring to FIG. 2, the transaction system 30 of a non-limiting embodiment of the present disclosure is displayed. Computer 10 may reside on one or more networks. In some non-limiting embodiments, computer 10 may be located on any device that may receive input from a device, such as, for example, a mobile device or user device 120. Computer 10 may comprise a memory 20, a central processing unit, an input and output (“I/O”) device 60, a processor 40, an interface 50, and a hard disk 70. Memory 20 may store computer-readable instructions that may instruct computer 10 to perform certain processes. In particular, memory 20 may store a plurality of application programs that are under development. Memory 20 also may store a plurality of scripts that include one or more testing processes for evaluation of applications or input. When computer-readable instructions, such as an application program or a script, are executed by the CPU, the computer-readable instructions stored in memory 20 may instruct the CPU or transaction system 30 to perform a plurality of functions. Examples of such functions are described below with respect to FIGS. 3-4.

In some non-limiting embodiments of the present disclosure, the CPU may be transaction system 30. In some implementations, when computer-readable instructions, such as an application program or a script, are executed by the CPU, the computer-readable instructions stored in memory 20 may instruct the transaction system 30 to analyze a transaction request and reserve currency at an ATM. In some non-limiting embodiments, Computer 10 may be located on the user device 120, on a remote server, on the cloud, or any combination thereof. In some non-limiting embodiments, Computer 10 and transaction system 30 may communicate with user device 120 via network 80.

I/O device 60 may receive data from network 80, database 90, local database 95, data from other devices and sensors connected to transaction system 30, and input from a user and provide such information to the transaction system 30. I/O device 60 may transmit data to network 80, database 90, and/or local database 95. I/O device 60 may transmit data to other devices connected to transaction system 30, and may transmit information to a user (e.g., display the information, send an e-mail, make a sound) or transmit information formatted for display on a user device 120 or any other device associated with the user. Further, I/O device 60 may implement one or more of wireless and wired communication between user device 120 or transaction system 30 and other devices within or external to network 80. I/O device 60 may receive one or more of data from another server or a network 80. The transaction system 30 may be a processing system, a server, a plurality of servers, or any combination thereof. In addition, I/O device 60 may communicate received input or data from user device 120 to transaction system 30.

Transaction system 30 may be located on the cloud, on an external network, on user device 120, or any combination thereof. Transaction system 30 may be SaaS or entirely located on the user device 120. Furthermore, some non-limiting configurations of transaction system 30 may be located exclusively on a user device 120, such as, for example, a mobile device or tablet. Transaction system 30 may also be accessed by a user on user device 120. In some non-limiting embodiments, the user may connect to network 80 to access transaction system 30 using the user device 120.

Further referring to FIG. 2, in some non-limiting embodiments of the present disclosure, a mobile application may be installed on the user device 120. The mobile application may facilitate communication with transaction system 30, database 90, local database 95, or any other entity. In some non-limiting embodiments, a program on user device 120 may track, record, and report input information to the transaction system 30, such as, for example, past transaction requests and corresponding data. In systems and methods of the present disclosure, such as when the transaction system 30 is located on user device 120, user device 120 may not be connected to network 80 while in communication with transaction system 30.

In some non-limiting embodiments, user device 120 may store transaction requests, preferred ATMs, previously used ATMS, currency denomination preferences, and any other data associated with the transaction system 30 locally on the user device 120. In some non-limiting embodiments of the present disclosure, an application on the user device 120 may communicate with transaction system 30 to manage analysis, data, and corresponding user input or requests on the user device 120. User device 120 may have a user interface for the user to communicate with transaction system 30. An application on the user device 120 and transaction system 30 may maintain an offline copy of all information. In some non-limiting embodiments of the present disclosure, in which the transaction system 30 is located partially or completely on user device 120, transaction system 30 may facilitate communications regarding transaction requests to a financial institution. In such situations, transaction system 30 may rely on information stored locally on user device 120. User may store ATM preferences, such as a preferred location, on the user device 120. In some systems and methods of the present disclosure, transaction system 30 may rely on information in a cloud database.

Further, transaction system 30 may communicate with a transaction network 35 via the network 80. Transaction network 35 may include a single transaction servicer or multiple transaction servicers. In some non-limiting embodiments, transaction system 30 may determine, in response to receiving a request to initiate a transaction from a user device 120, a set of transaction servicers. The transaction services may be located within a predetermined distance of a current location of the user or a location indicated in the transaction request. In some non-limiting embodiments, each transaction servicer may be an account holder at a financial institution. In some non-limiting embodiments, all transaction servicers are other humans. In some non-limiting embodiments, some transaction servicers are humans and other transaction servicers are ATMs.

Transaction system 30 may determine whether a transaction request associated with an account would clear the account if the transaction request is processed. The transaction request may originate from a user device 120. Transaction system 30 may determine whether a particular transaction servicer has sufficient resources to service the transaction request. In some non-limiting embodiments, transaction system 30 may determine which of a network of transaction servicers in the transaction network 35 has sufficient resources (e.g., preferred denomination or currency) to service the transaction request. The transaction network 35 may include multiple transaction servicers within a predetermined distance of a particular location. For example, in some non-limiting embodiments, transaction system 30 may be able to determine a user location based on the transaction request. In addition, in other non-limiting embodiments, a user may submit a transaction request including a preferred location that differs from a current user location. In some non-limiting embodiments of the present disclosure, a transaction request may include a cap increase request to increase the maximum amount a user can withdraw. This maximum amount may be set by a financial institution.

For each transaction servicer that has enough currency to complete the transaction to the user, transaction system 30 may transmit identifying information. The identifying information may identify the user requesting the transaction. In some non-limiting embodiments, both the user and transaction servicers have a mobile application that may receive and display identifying information such as, for example, a user's picture and/or name. In other non-limiting embodiments, transaction servicers may receive the current location or preferred location of the user.

Transaction system 30 may facilitate a transaction between the requesting user and the transaction servicer. In some non-limiting embodiments, transaction system 30 may send a transaction servicer identifying information indicating requested currency and enough information for the transaction servicer to locate the user to complete the transaction. Upon completion of the transaction, such as receiving cash from the transaction servicer, user may utilize a user interface on the user device 120 to send a confirmation to transaction system 30. In addition, transaction system 30 may, in response to receiving a confirmation that the transaction has been completed, apply the transaction to a corresponding account of the user.

FIG. 3 illustrates communication points in a transaction system ecosystem according to a non-limiting embodiment of the present disclosure. In some non-limiting embodiments, a first account holder 310 may submit a transaction request using a user device 120. The transaction request may be sent by the user device 120 to the transaction system 30 via network 80. In some non-limiting embodiments, transaction system 30 may include an issuer bank 330 and a support system 300. Further, transaction system 30 may determine whether a transaction request associated with an account would clear the account if the transaction request is processed. Transaction system 30 may communicate with a financial institution such as issuer bank 330 to determine whether the account has enough funds to process the transaction request.

In some non-limiting embodiments, transaction system 30 may also determine if accounts for potential transaction servicers have sufficient resources to fulfill the transaction request. Transaction system 30 may communicate with multiple ATMs and other account holders in the transaction network 35 to determine which have sufficient resources to service the transaction request. In addition, transaction system 30 may transmit an instruction reserving a corresponding amount of currency for the transaction request at a particular second account holder for a predetermined time frame. The particular second account holder may be determined based on available resources, location, transaction history of the user, a location preference in the transaction request, etc. In some non-limiting embodiments, a transaction servicer may be an ATM.

For example, in some non-limiting embodiments, a user 100 may use the user device 120 to submit a transaction request to withdraw $100 from an account associated with the user. The request may be received by a transaction system 30. In some non-limiting embodiments, the transaction system 30 may be a financial institution, such as, for example, an issuer bank 330. The transaction request may be submitted through a mobile application on the user device 120 supported by a financial institution. In some non-limiting embodiments, the transaction request may include a preference or priority list of currency denominations for the $100. In some non-limiting embodiments, the transaction request may specify a preference for a type of currency, such as, for example, in Euros before US Dollars.

The transaction system 30 may determine a location of the user device 120 based on the transaction request. In some non-limiting embodiments, the user 100 may indicate a preferred location that differs from the location of the user device 120. Users may submit a list of preferred transaction servicers or a list of preferred locations with the transaction request. Transaction system 30 may use the location information to determine transaction servicers near the location that have sufficient resources to fulfill the transaction request. Transaction system 30 may communicate with support system 300, which may include local and regional data centers, to determine suitable transaction servicers. In addition, transaction system 30 may communicate with a transaction network 35 and an issuing bank's data center to determine suitable transaction servicers to fulfill the transaction request.

Transaction system 30 may submit the transaction request to suitable transaction servicers within a predetermined distance of a current or preferred location of the user. In some non-limiting embodiments of the present disclosure, the transaction servicer may decide whether or not to complete the transaction requested by the user. Transaction system 30 may submit a potential transaction to the transaction network 35 and a second account holder 320 may select to complete the transaction with the user. In addition, transaction system 30 may transmit identifying information for each transaction servicer that has enough currency to complete the transaction to the user. Transaction system 30 may receive a confirmation from one transaction servicer indicating that the transaction request will be filled. In some non-limiting embodiments, a second account holder 320 may receive interest on the transaction, reward points, a service fee, etc. for completing the transaction. In some non-limiting embodiments, transaction system 30 may determine a second account holder 320 based on preferred configurations previously set by the user or based on preferences indicated in the transaction request. The amount and predetermined distance of transaction requests may be limited by an issuing bank or financial institution. In some non-limiting embodiments, a user may schedule a transaction with a particular second account holder 320 in the transaction network 35 at a future date. In some non-limiting embodiments, the predetermined distance may be indicated in a transaction request and determined by a user on user device 120.

Upon receiving a selection, transaction system 30 may communicate information to the first account holder 310 to meet with the second account holder 320 to complete the transaction. The transaction system 30 may format indications or notifications for display on a user interface on the user device 120. In addition, transaction system 30 may transmit further user identifying information for to the transaction servicer.

Transaction system 30 may receive a confirmation that the transaction has been completed. In addition, transaction system 30 may apply the transaction to a corresponding account of the user. Transaction system 30 may determine that the transaction has been fulfilled by a first transaction servicer based on the confirmation from a mobile device of the user, wherein the set of transaction servicers may include the first transaction servicer. In some non-limiting embodiments, transaction system 30 may debit a cash amount of the transaction from an account of the user at an issuing bank. Further, transaction system 30 may credit the cash amount of the transaction to the account of the first transaction servicer at the issuing bank.

FIG. 4 is a flow chart for a method for facilitating a transaction request via a transaction servicer according to a non-limiting embodiment of the present disclosure. In step 400, transaction system 30 may determine, in response to receiving a request to initiate a transaction from a user, a set of transaction servicers that are located within a predetermined distance of a current location of the user. In some non-limiting embodiments, each transaction servicer may be an account holder at a financial institution. In some non-limiting embodiments, the request may be received from a mobile device of the user over an SMS protocol. In other non-limiting embodiments, transaction system 30 may receive the request from a mobile application of a user device 120 of the user.

In some non-limiting embodiments of the present disclosure, transaction system 30 may receive the transaction request from user device 120 over a Short Message Service (SMS) protocol. In addition, transaction system 30 may determine a monetary denomination and currency type based on the transaction request. Any preference indicated in the transaction request may be ranked according to a priority specified in the transaction request. For example, a user may request $100 preferably in fifty dollar bills, but secondarily in twenty dollar bills. In some non-limiting embodiments, transaction system 30 may adjust a maximum withdraw amount of the account based on the transaction request.

Transaction system 30 may determine multiple transaction servicers within a predetermined range of a current location of a user associated with the account. The transaction system 30 may determine a predetermined distance for a transaction at a future date indicated by the transaction request. In other non-limiting embodiments, an issuing bank associated with the account of the user may set a predetermined distance for a transaction or for a location. the predetermined distance may be determined based on a population density of the current or preferred location of the user. In some non-limiting embodiments, transaction system 30 may determine an transaction servicer location radius based on the transaction request. The transaction servicer location radius may be based on a current location of the user device 120 or a requested location submitted in the transaction request.

Further in step 410, transaction system 30 may determine which of multiple transaction servicers have sufficient resources (e.g., preferred currency, preferred denominations, within predetermined distance) to provide a particular set of currency requested in the transaction request. Transaction system 30 may sent a message to the transaction network 35 requesting a reply by a transaction servicer that has sufficient resources to fulfill the transaction request. Prior registration and/or authentication may be required before a transaction servicer is able to participate in the system.

In some non-limiting embodiments, only a portion of the available transaction servicers may have suitable resources to fulfill the transaction request. For each transaction servicer that has enough currency to complete the transaction to the user, transaction system 30 may transmit identifying information to the qualified transaction servicer as shown in step 420. In some non-limiting embodiments, transaction system 30 may transmit to each of the transaction servicers at least one requested monetary denomination of the cash amount determined based on the request from the user. User or transaction servicer may reach out to make contact with one another, which in some cases may occur over an SMS protocol.

Once a user collects the requested funds from a transaction servicer, the user may send a message to the transaction system 30 indicating that the transaction has been completed. Upon completion of the transaction, transaction system 30 in step 430 may determine that the transaction has been fulfilled by a first transaction servicer of the set of transaction servicers based on a confirmation received from a mobile device of the user. The transaction system 30 may also send a confirmation message to the transaction servicer indicating completion of the transaction. In some non-limiting embodiments, the transaction may be fulfilled by multiple transaction servicers. Transaction system 30 may determine that the transaction has been fulfilled by a first transaction servicer based on the confirmation from a mobile device of the user, wherein the set of transaction servicers may include the first transaction servicer. In some non-limiting embodiments, transaction system 30 may determine, based on a confirmation from the user, that the first transaction servicer transferred in person a requested cash amount to the user.

In response to determining that the transaction has been fulfilled in person by a first transaction servicer of the set of transaction servicers, transaction system 30 may debit a cash amount of the transaction from an account of the user at an issuing bank. Further in response to determining that the transaction has been fulfilled by a first transaction servicer based on the confirmation from a mobile device of the user, transaction system 30 may transmit a confirmation message to the first transaction servicer over an SMS protocol. In some non-limiting embodiments, communications between the transaction system 30 and transaction servicers may be over an SMS protocol. For example, transaction system 30 may transmit a transaction message that includes identifying information for a user over an SMS protocol to each transaction servicer that has sufficient resources to complete the transaction.

In addition, transaction system 30 may credit the cash amount of the transaction and an interest based on the cash amount to the account of the first transaction servicer at the issuing bank. In addition, transaction system 30 may credit an interest based on the cash amount to the account of the first transaction servicer. In some non-limiting embodiments, transaction system 30 may credit a service payment based on the cash amount to the account of the first transaction servicer. In some non-limiting embodiments, the first account holder may be associated with a first financial institution and the second account holder may be associated with a second financial institution. In some non-limiting embodiments, an account of the first account holder may be associated with a first issuing bank, and an account of the second account holder may be associated with a different issuing bank.

Further, transaction system 30 may, in response to determining that the transaction has been fulfilled by the first transaction servicer based on the confirmation from the mobile device of the user, transmit a confirmation message to the first transaction servicer over an SMS protocol. The confirmation message may indicate that the cash amount of the transaction has been credited to the account of the first transaction servicer at the issuing bank.

The flowcharts and diagrams in FIGS. 1-4 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, “each” means “each and every” or “each of a subset of every,” unless context clearly indicates otherwise.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method, comprising:
in response to receiving a request to initiate a transaction from a user, determining, using one or more processors, a set of transaction servicers that are located within a predetermined distance of a current location of the user, wherein each transaction servicer is an account holder;
determining, using one or more processors, and for each of the transaction servicers in the set, whether the transaction servicer has enough currency to complete the transaction;
transmitting identifying information for each transaction servicer that has enough currency to complete the transaction to the user; and
in response to receiving a confirmation that the transaction has been completed, applying the transaction to a corresponding account of the user.

2. The method of claim 1, further comprising:
determining that the transaction has been fulfilled by a first transaction servicer based on the confirmation from a mobile device of the user, the set of transaction servicers comprising the first transaction servicer; and
wherein applying the transaction to a corresponding account of the user comprises:
debiting, using one or more processors, a cash amount of the transaction from an account of the user at an issuing bank; and
crediting, using one or more processors, the cash amount of the transaction to the account of the first transaction servicer at the issuing bank.

3. The method of claim 2, wherein determining that the transaction has been fulfilled by a first transaction servicer based on the confirmation from a mobile device of the user comprises:
determining, based on the confirmation, that the first transaction servicer transferred in person the cash amount to the user.

4. The method of claim 2, wherein crediting, using one or more processors, the cash amount of the transaction to the account of the first transaction servicer at the issuing bank comprises:
crediting an interest based on the cash amount to the account of the first transaction servicer.

5. The method of claim 2, wherein crediting, using one or more processors, the cash amount of the transaction to the account of the first transaction servicer at the issuing bank comprises:
crediting a service payment based on the cash amount to the account of the first transaction servicer.

6. The method of claim 2, wherein the request to initiate the transaction specifies at least one monetary denomination of the cash amount.

7. The method of claim 2, further comprising:
in response to determining that the transaction has been fulfilled by a first transaction servicer based on the confirmation from a mobile device of the user:
transmitting a confirmation message to the first transaction servicer over an SMS protocol.

8. The method of claim 1, wherein transmitting identifying information for each transaction servicer that has enough currency to complete the transaction to the user comprises:
transmitting to each of the transaction servicers at least one requested monetary denomination of a cash amount determined based on the request.

9. The method of claim 1, wherein transmitting identifying information for each transaction servicer that has enough currency to complete the transaction to the user comprises:
transmitting a transaction message over an Short Message Service (SMS) protocol.

10. The method of claim 1, wherein the request is received from a mobile device of the user over an SMS protocol.

11. The method of claim 1, wherein the request is received from a mobile application on a mobile device of the user.

12. The method of claim 1, wherein the predetermined distance is determined based on a population density of the current location of the user.

13. A computer configured to access a storage device, the computer comprising:
a processor; and
a non-transitory, computer-readable storage medium storing computer-readable instructions that when executed by the processor cause the computer to perform:
in response to receiving a request to initiate a transaction from a user, determining a set of transaction servicers that are located within a predetermined distance of a current location of the user, wherein each transaction servicer is an account holder;
determining, for each of the transaction servicers in the set, whether the transaction servicer has enough currency to complete the transaction;
transmitting identifying information for each transaction servicer that has enough currency to complete the transaction to the user;
determining that the transaction has been fulfilled by a first transaction servicer of the set of transaction servicers based on a confirmation received from a mobile device of the user;
in response to determining that the transaction has been fulfilled by a first transaction servicer of the set of transaction servicers:
debiting a cash amount of the transaction from an account of the user at an issuing bank; and
crediting the cash amount of the transaction to the account of the first transaction servicer at the issuing bank.

14. The system of claim 13, wherein determining that the transaction has been fulfilled by the first transaction servicer of the set of transaction servicers based on the confirmation received from a mobile device of the user comprises:
determining, based on the confirmation, that the first transaction servicer transferred in person the cash amount to the user.

15. The system of claim 13, wherein crediting the cash amount of the transaction to the account of the first transaction servicer at the issuing bank comprises:
crediting an interest based on the cash amount to the account of the first transaction servicer.

16. The system of claim 13, wherein the request to initiate the transaction specifies at least one monetary denomination of the cash amount.

17. The system of claim 13, further comprising:
in response to determining that the transaction has been fulfilled by the first transaction servicer based on the confirmation from the mobile device of the user:
transmitting a confirmation message to the first transaction servicer over an SMS protocol, the confirmation message indicating that the cash amount of the transaction has been credited to the account of the first transaction servicer at the issuing bank.

18. The system of claim 13, wherein transmitting identifying information for each transaction servicer that has enough currency to complete the transaction to the user comprises:
transmitting to each of the transaction servicers at least one requested monetary denomination of the cash amount determined based on the request.

19. The system of claim 13, wherein the predetermined distance is determined based on a population density of the current location of the user.

20. A non-transitory computer-readable medium having instructions stored thereon that are executable by a computing system to perform operations comprising:
in response to receiving a request to initiate a transaction from a user, determining a set of transaction servicers that are located within a predetermined distance of a current location of the user, wherein each transaction servicer is an account holder;
determining, for each of the transaction servicers in the set, whether the transaction servicer has enough currency to complete the transaction;
transmitting identifying information for each transaction servicer that has enough currency to complete the transaction to the user;
determining that the transaction has been fulfilled by a first transaction servicer of the set of transaction servicers based on a confirmation received from a mobile device of the user;
in response to determining that the transaction has been fulfilled in person by a first transaction servicer of the set of transaction servicers:
debiting a cash amount of the transaction from an account of the user at an issuing bank; and
crediting the cash amount of the transaction and an interest based on the cash amount to the account of the first transaction servicer at the issuing bank.
